(19) United States
(12) Patent Application Publication
(10) Pub. No.: US 2020/0365902 A1
(43) Pub. Date: Nov. 19, 2020

(54) CONDUCTING POLYMER NETWORK-BASED CATHODE-PROTECTING LAYER FOR LITHIUM METAL SECONDARY BATTERY

(71) Applicant: Nanotek Instruments, Inc., Dayton, OH (US)

(72) Inventor: Bor Z. Jang, Centerville, OH (US)

(73) Assignee: Nanotek Instruments, Inc., Dayton, OH (US)

(21) Appl. No.: 16/411,645

(22) Filed: May 14, 2019

(51) Int. Cl. H01M 4/62; H01M 10/052; H01M 4/36

(52) U.S. Cl. CPC H01M 4/628; H01M 10/052; H01M 2004/028; H01M 4/366; H01M 4/624

(57) ABSTRACT

Provided is a lithium metal secondary battery comprising a cathode, an anode, and an electrolyte-separator assembly disposed between the cathode and the anode, wherein the anode comprises an anode current collector or an anode active material layer supported by an anode current collector and the cathode comprises: (a) a cathode active material layer preferably supported on a cathode current collector; and (b) a cathode-protecting layer in physical contact with the cathode active material layer and in ionic contact with the electrolyte-separator assembly, wherein the cathode-protecting layer has a thickness from 10 nm to 500 μm and comprising an electrically and ionically conducting network of cross-linked polymer chains having a lithium ion conductivity from 10⁻⁸ to 5×10⁻² S/cm and an electron conductivity from 10⁻⁸ to 10³ S/cm.

### FIELD

The present disclosure relates to the field of rechargeable lithium metal batteries, a method of manufacturing same, and a method of improving the cycle stability of all rechargeable lithium metal batteries.

### BACKGROUND

Lithium-ion and lithium (Li) metal cells (including lithium metal secondary cell, lithium-sulfur cell, lithium-selenium cell, Li-air cell, etc.) are considered promising power sources for electric vehicle (EV), hybrid electric vehicle (HEV), and portable electronic devices, such as lap-top computers and mobile phones. Lithium metal has the highest capacity (3,861 mAh/g) compared to any other metal or metal-intercalated compound (except Li_{4.4}Si) as an anode active material. Hence, in general, rechargeable Li metal batteries have a significantly higher energy density than lithium ion batteries.

Historically, rechargeable lithium metal batteries were produced using non-lithiated compounds having high specific capacities, such as TiS₂, MoS₂, MnO₂, CoO₂ and V₂O₅, as the cathode active materials, which were coupled with a lithium metal anode. When the battery was discharged, lithium ions were dissolved from the lithium metal anode and transferred to the cathode through the electrolyte and, thus, the cathode became lithiated.

One of the most promising energy storage devices is the lithium-sulfur (Li—S) cell since the theoretical capacity of Li is 3,861 mAh/g and that of S is 1,675 mAh/g. In its simplest form, a Li—S cell consists of elemental sulfur as the positive electrode and lithium as the negative electrode. The lithium-sulfur cell operates with a redox couple, described by the reaction S₈+16Li↔8Li₂S that lies near 2.2 V with respect to Li⁺/Li°. This electrochemical potential is approximately ⅔ of that exhibited by conventional positive electrodes (e.g. LiMnO₄). However, this shortcoming is offset by the very high theoretical capacities of both Li and S. Thus, compared with conventional intercalation-based Li-ion batteries, Li—S cells have the opportunity to provide a significantly higher energy density (a product of capacity and voltage). Assuming complete reaction to Li₂S, energy densities values can approach 2,500 Wh/kg and 2,800 Wh/l, respectively, based on the combined Li and S weight or volume. If based on the total cell weight or volume, the energy densities of optimally designed Li—S cell configurations can reach approximately 1,000 Wh/kg and 1,100 Wh/l, respectively. However, the current Li-sulfur cells reported by industry leaders in sulfur cathode technology have a maximum cell specific energy of 250-400 Wh/kg (based on the total cell weight), which is far below what is possible.

In summary, despite its considerable advantages, the Li—S cell is plagued with several major technical problems that have thus far hindered its widespread commercialization:
(1) Conventional lithium metal cells still have dendrite formation and related internal shorting issues.
(2) Sulfur or sulfur-containing organic compounds are highly insulating, both electrically and ionically. To enable a reversible electrochemical reaction at high current densities or charge/discharge rates, the sulfur must maintain intimate contact with an electrically conductive additive. Various carbon-sulfur composites have been utilized for this purpose, but only with limited success owing to the limited scale of the contact area. Typical reported capacities are between 300 and 550 mAh/g (based on the cathode carbon-sulfur composite weight) at moderate rates.
(3) The cell tends to exhibit significant capacity decay during discharge-charge cycling due to the so-called shuttle effect. This is mainly due to the high solubility of the lithium polysulfide anions formed as reaction intermediates during both discharge and charge processes in the polar organic solvents used in electrolytes. During cycling, the lithium polysulfide anions can migrate through the separator to the Li negative electrode whereupon they are reduced to solid precipitates (Li₂S₂ and/or Li₂S), causing active mass loss. In addition, the solid product that precipitates on the surface of the positive electrode during discharge becomes electrochemically irreversible, which also contributes to active mass loss.
(4) More generally speaking, a significant drawback with cells containing cathodes comprising elemental sulfur, organosulfur and carbon-sulfur materials relates to the dissolution and excessive out-diffusion of soluble sulfides, polysulfides, organo-sulfides, carbon-sulfides and/or carbon-polysulfides (hereinafter referred to as anionic reduction products) from the cathode into the rest of the cell. This phenomenon is commonly referred to as the Shuttle Effect. This process leads to several problems: high self-discharge rates, loss of cathode capacity, corrosion of current collectors and electrical leads leading to loss of electrical contact to active cell components, fouling of the anode surface giving rise to malfunction of the anode, and clogging of the pores in the cell membrane separator which leads to loss of ion transport and large increases in internal resistance in the cell.

In response to these challenges, new electrolytes, protective films for the lithium anode, and solid electrolytes have been developed. Some interesting cathode developments have been reported recently to contain lithium polysulfides; but, their performance still fall short of what is required for practical applications. Despite the various approaches proposed for the fabrication of high energy density Li—S cells, there remains a need for cathode materials, production processes, and cell operation methods that retard the out-diffusion of S or lithium polysulfide from the cathode compartments into other components in these cells, improve the utilization of electro-active cathode materials (S utilization efficiency), and provide rechargeable Li—S cells with high capacities over a large number of cycles.

Most significantly, lithium metal (including pure lithium, lithium alloys of high lithium content with other metal elements, or lithium-containing compounds with a high lithium content; e.g. >80% or preferably >90% by weight Li) still provides the highest anode specific capacity as compared to essentially all other anode active materials (except pure silicon, but silicon has pulverization issues). Lithium metal would be an ideal anode material in a lithium-sulfur secondary battery if dendrite related issues could be addressed. The cathode can contain sulfur-, selenium-, or organic material-based cathode active materials that all exhibit the shuttle effect. The cathode can also contain inorganic materials since they can have some of their ingredients (e.g. Mn⁺ⁿ ions) dissolved in the electrolyte.

Hence, an object of the present disclosure is to provide a rechargeable lithium metal battery that exhibits an exceptionally high specific energy or high energy density and yet also delivers a long cycle life.

A specific object of the present disclosure is to provide a rechargeable lithium cell based on rational materials and battery designs that overcome or significantly reduce the following issues commonly associated with conventional Li metal cells: (a) dendrite formation (internal shorting); (b) extremely low electric and ionic conductivities of sulfur and organic materials, requiring large proportion (typically 30-55%) of non-active conductive fillers and having significant proportion of non-accessible or non-reachable sulfur or metal polysulfides); (c) poor sulfur utilization efficiency; (d) dissolution of S, lithium polysulfide, and organic materials in the electrolyte; (e) migration of lithium polysulfides and organic species from the cathode to the anode (which irreversibly react with Li at the anode), resulting in active material loss and capacity decay (the shuttle effect); and (f) short cycle life.

### SUMMARY

The disclosure provides a lithium metal secondary battery, comprising a cathode, an anode, an electrolyte-separator assembly disposed between the cathode and the anode, wherein the anode comprises an anode current collector or an anode active material layer supported by an anode current collector, and the cathode comprises: (a) a cathode active material layer; and (b) a cathode-protecting layer in physical contact with the cathode active material layer and in ionic contact with the electrolyte-separator assembly, having a thickness from 10 nm to 500 μm and comprising an electrically and ionically conducting network of cross-linked polymer chains having a lithium ion conductivity from 10⁻⁸ to 5×10⁻² S/cm and an electron conductivity from 10⁻⁸ to 10³ S/cm. The cathode-protecting layer can be in a form of a free-standing film or a thin coating (disposed between a porous separator or solid electrolyte and the cathode active material layer). The thin coating is deposited on a primary surface (facing the separator) of the cathode active material layer.

The invented lithium metal secondary battery may include, but not limited to, any battery that makes use of lithium metal or lithium metal alloy as the primary anode active material; e.g. a rechargeable lithium metal cell, a lithium-sulfur cell, a lithium-selenium cell, a lithium-sulfur/selenium cell (where the cathode active material contains both S and Se), or lithium-air (or lithium-oxygen cell) having oxygen as the cathode active material.

It may be noted that a lithium metal battery or lithium-ion battery can have its lithium ion source initially located in the anode or the cathode when the battery cell is made. In a typical lithium-ion battery, the lithium ion source is stored in the cathode (e.g. Li element in the LiCoO₂ or LiMn₂O₄ formula). During the first charge process (e.g. during the first electrochemical formation process after the cell is made), some of the Li ions come out of the cathode active material and move to the anode side. The cathode active material, by losing x amount, becomes Li₍₁₋ₓ₎CoO₂ or Li₍₁₋ₓ₎Mn₂O₄, where 0<x≤1.

In a typical lithium metal battery, lithium source is located in the anode side in the form of a Li foil, Li coating, Li particles etc. During the first discharge procedure, lithium ions are ionized and released from this lithium source and move to the cathode side. During a subsequent recharge procedure, lithium ions return to the anode side, attempting to deposit onto the surface of a current collector or the unused lithium foil.

In certain embodiments, the disclosure provides a lithium metal secondary battery comprising a cathode, an anode, an electrolyte-separator assembly disposed between the cathode and the anode, wherein the anode comprises an anode current collector (substantially free of lithium on the current collector surface when the cell is initially made) and the cathode contains (a) a cathode active material layer (preferably supported by a cathode current collector, such as Al foil) and (b) a cathode-protecting layer (a film or coating) in physical contact with the cathode active material layer and in ionic contact with the electrolyte-separator assembly (the cathode-protecting layer being disposed between the cathode active material layer and the separator/electrolyte), having a thickness from 10 nm to 500 μm and comprising an electrically and ionically conducting network of cross-linked polymer chains having a lithium ion conductivity from 10⁻⁸ to 5×10⁻² S/cm and an electron conductivity from 10⁻⁸ to 10³ S/cm; wherein the battery includes lithium-sulfur battery or lithium-selenium battery. The lithium ion source may be implemented in the cathode active material (as in a typical lithium-ion battery) or in the anode side (e.g. as a lithium foil or lithium coating coated on the surface of a current collector).

In certain embodiments, the conducting network of cross-linked polymer chains comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

In some embodiments, the electrolyte-separator assembly comprises an electrolyte or a combination of a porous separator and an electrolyte in ionic contact with the anode and the cathode. When the electrolyte contains a solid state electrolyte, a porous separator or membrane may or may not be necessary. A porous separator is normally required if the electrolyte is a liquid or gel electrolyte.

In certain embodiments, the electrolyte is selected from organic liquid electrolyte, ionic liquid electrolyte, polymer gel electrolyte, solid-state electrolyte, quasi-solid electrolyte having a lithium salt dissolved in an organic or ionic liquid with a lithium salt concentration preferably higher than 2.0 M (from 2.0 M to 14 M), or a combination thereof.

Preferably, the anode active material layer, the electrolyte (e.g. solid-state electrolyte) or electrolyte/separator assembly, the cathode-protecting layer, and the cathode layer are laminated together in such a manner (e.g. roll-pressed together) that the resulting cell is under a compressive stress or strain for the purpose of maintaining a good contact between the cathode active material layer and the cathode-protecting layer.

In the lithium metal secondary battery, the non-solid state electrolyte is selected from organic liquid electrolyte, ionic liquid electrolyte, polymer gel electrolyte, quasi-solid electrolyte having a lithium salt dissolved in an organic or ionic liquid with a lithium salt concentration higher than 2.0 M (from 2.0 M to 14 M; typically from 2.5 M to 10 M; and more typically from 3.5M to 7 M), or a combination thereof.

It is well-known in the art that a porous separator may not be necessary if the electrolyte is a solid-state electrolyte; but, a porous separator is normally required in order to electronically separate the anode from the cathode if the electrolyte contains a liquid ingredient, such as in an organic liquid electrolyte, ionic liquid electrolyte, polymer gel electrolyte (polymer+liquid solvent), and quasi-solid electrolyte.

The invented conducting polymer network layer, in a dried or gel state, appears to play the roles of protecting the cathode, preventing any cathode active material (e.g. lithium polysulfide or polyselenide, or organic-based cathode active materials) dissolved in the electrolyte from migrating over to the anode side. These cathode species, upon migration to the anode side, often irreversibly react with the anode species (e.g. lithium metal) and cannot return back to the cathode side. Such a “shuttle effect” would lead to a rapid decay in charge storage capacity.

The foil or coating of lithium or lithium alloy in the anode may be supported by a current collector (e.g. a Cu foil, a Ni foam, a porous layer of nano-filaments, such as graphene sheets, carbon nanofibers, carbon nano-tubes, etc.).

The network of conducting polymer chains in the cathode-protecting layer may further contain a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

In some embodiments, the conductive polymer network further contains a lithium ion-conducting additive dispersed therein, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4.

In certain embodiments, the cathode-protecting layer comprises from 0.01% to 50% of a reinforcement material dispersed therein, wherein the reinforcement material is selected from a glass fiber, ceramic fiber, polymer fiber, or a combination thereof. The reinforcement may also be selected from glass particles, ceramic particles, polymer particles, etc. The reinforcement material can increase the mechanical strength of the cathode-protecting layer. The reinforcement material may be electrically conductive, such as carbon nanotube, carbon nano-fiber, carbon fiber, graphite fiber, graphene, polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, or a combination thereof.

The cathode active material may be selected from an inorganic material, an organic material, a polymeric material, or a combination thereof. The inorganic material may be selected from a metal oxide, a metal phosphate, a metal silicide, a metal selenide, a metal sulfide, sulfur, an alkali metal polysulfide, selenium, an alkali metal polyselenide, a Se/S alloy or mixture, or a combination thereof.

The inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

In certain preferred embodiments, the inorganic material is selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In certain preferred embodiments, the inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

In certain preferred embodiments, the inorganic material is selected from a transition metal dichalcogenide, a transition metal trichalcogenide, or a combination thereof. The inorganic material is selected from TiS₂, TaS₂, MoS₂, NbSe₃, MnO₂, CoO₂, an iron oxide, a vanadium oxide, or a combination thereof.

The cathode active material layer may contain a metal oxide containing vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In some embodiments, the inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The cathode active material layer may contain an organic material or polymeric material selected from poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, hexaazatrinaphtylene (HATN), hexaazatriphenylene hexacarbonitrile (HAT(CN)₆), 5-benzylidene hydantoin, isatine lithium salt, pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer is selected from poly[methanetetryl-tetra(thiomethylene)] (PMTTM), poly(2,4-dithiopentanylene) (PDTP), a polymer containing poly(ethene-1,1,2,2-tetrathiol) (PETT) as a main-chain thioether polymers, a side-chain thioether polymer having a main-chain consisting of conjugating aromatic moieties, and having a thioether side chain as a pendant, poly(2-phenyl-1,3-dithiolane) (PPDT), poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

In other embodiments, the cathode active material layer contains an organic material selected from a phthalocyanine compound, such as copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

In certain embodiments, the cathode active material comprises a sulfur-containing material selected from a sulfur-carbon hybrid, sulfur-graphite hybrid, sulfur-graphene hybrid, conducting polymer-sulfur hybrid, metal sulfide, sulfur compound, selenium-carbon hybrid, selenium-graphite hybrid, selenium-graphene hybrid, conducting polymer-selenium hybrid, metal selenide, selenium compound, or a combination thereof. These cathode materials can be used in a Li—S cell, Li—Se cell, and Li—S/Se cell. The Li—S/Se cell contains S/Se mixture or S/Se alloy as a cathode active material.

The metal sulfide may contain MₓS_{y} or MₓSe_{y}, wherein x is an integer from 1 to 3 and y is an integer from 1 to 10, and M is a metal element selected from an alkali metal, an alkaline metal selected from Mg or Ca, a transition metal, a metal from groups 13 to 17 of the periodic table, or a combination thereof. The metal element M is selected from Li, Na, K, Mg, Zn, Cu, Ti, Ni, Co, Fe, or Al. The metal sulfide may contain Li₂S₁, Li₂S₂, Li₂S₃, Li₂S₄, Li₂S₅, Li₂S₆, Li₂S₇, Li₂S₈, Li₂S₉, Li₂S₁₀, and a combination thereof.

The cathode active material is preferably in a form of nanoparticle (spherical, ellipsoidal, and irregular shape), nanowire, nanofiber, nanotube, nanosheet, nanobelt, nanoribbon, nanodisc, nanoplatelet, or nanohorn having a thickness or diameter less than 100 nm. These shapes can be collectively referred to as “particles” unless otherwise specified or unless a specific type among the above species is desired. Further preferably, the cathode active material has a dimension less than 50 nm, even more preferably less than 20 nm, and most preferably less than 10 nm. In some embodiments, one particle or a cluster of particles may be coated with or embraced by a layer of carbon disposed between the particle(s) and/or a sulfonated elastomer composite layer (an encapsulating shell).

The cathode layer may further contain a graphite, graphene, or carbon material mixed with the cathode active material particles. The carbon or graphite material is selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, or a combination thereof. Graphene may be selected from pristine graphene, graphene oxide, reduced graphene oxide, graphene fluoride, hydrogenated graphene, nitrogenated graphene, functionalized graphene, etc.

The cathode active material particles may be coated with or embraced by a conductive protective coating, selected from a carbon material, graphene, electronically conductive polymer, conductive metal oxide, or conductive metal coating.

The present disclosure also provides a lithium metal-air battery comprising an air cathode, an anode comprising the anode-protecting layer as defined above, and a porous separator or membrane or solid-state electrolyte disposed between the anode and the air cathode. In the air cathode, oxygen from the open air (or from an oxygen supplier external to the battery) is the primary cathode active material. The air cathode needs an inert material to support the lithium oxide material formed at the cathode. The applicants have surprisingly found that an integrated structure of conductive nano-filaments can be used as an air cathode intended for supporting the discharge product (e.g., lithium oxide).

Hence, a further embodiment of the present disclosure is a lithium metal-air battery, wherein the air cathode comprises an integrated structure of electrically conductive nanometer-scaled filaments that are interconnected to form a porous network of electron-conducting paths comprising interconnected pores, wherein the filaments have a transverse dimension less than 500 nm (preferably less than 100 nm). These nano-filaments can be selected from carbon nano-tubes (CNTs), carbon nano-fibers (CNFs), graphene sheets, carbon fibers, graphite fibers, etc.

The disclosure also provides a method of manufacturing a lithium battery, the method comprising: (a) providing a cathode active material layer and an optional cathode current collector to support the cathode active material layer; (b) providing an anode active material layer (e.g. containing a lithium metal or lithium alloy foil or coating) and an optional anode current collector to support the lithium metal or lithium alloy foil or coating; (c) providing an electrolyte in ionic contact with the anode active material layer and the cathode active material layer; (d) providing an cathode-protecting layer having a thickness from 1 nm to 100 μm (preferably from 10 nm to 10 μm) and comprising an electrically and ionically conducting network of cross-linked polymer chains having a lithium ion conductivity from 10⁻⁸ to 5×10⁻² S/cm and an electron conductivity from 10⁻⁸ to 10³ S/cm. This cathode-protecting layer is disposed between the cathode active material layer and a lithium ion-permeable membrane or a solid state electrolyte layer.

The disclosure also provides a method of improving the cycle-life of a lithium metal secondary battery. The method comprises implementing a conducting polymer network-based anode-protecting layer between a cathode active material layer and a porous separator or solid electrolyte in the battery. The cathode-protecting layer comprises an electrically and ionically conducting network of cross-linked polymer chains having a lithium ion conductivity from 10⁻⁸ to 5×10⁻² S/cm and an electron conductivity from 10⁻⁸ to 10³ S/cm. This conducting network may be in a dried state (without a solvent impregnated therein) or in a gel state (the network of conducting polymer chains being permeated by and swollen with a fluid (e.g. a solvent, an ionic liquid, possibly plus some lithium salt).

In some embodiments, the conducting network of cross-linked polymer chains comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

In the above-defined method, the step of implementing a cathode-protecting layer may be conducted by depositing a layer of a network of cross-linked polymer chains onto one primary surface of the cathode active material layer. This step comprises optionally compressing the protected cathode to improve the contact between the cathode-protecting layer and the cathode active material layer, followed by combining the protected cathode and the anode together to form the lithium metal secondary battery. A good contact between the cathode active material layer and the cathode-protecting layer is essential to reducing internal resistance.

In certain embodiments, the step of implementing the cathode-protecting layer is conducted by (i) preparing a cathode active material layer; (ii) preparing a free-standing layer comprising a conducting network of cross-linked polymer chains; and (iii) combining the cathode active material layer, the cathode-protecting layer, an anode, and an electrolyte together to form the lithium metal secondary battery. A compressive stress may be advantageously applied (e.g. via press-rolling) to improve the contact between the cathode-protecting layer and the cathode active material layer to be protected.

In certain embodiments, the procedure of providing a cathode-protecting layer contains providing a mixture/blend/composite of a network of conducting polymer chains with a lithium-ion conducting material, a reinforcement material (e.g. glass fibers, polymer fibers, etc.), or a combination thereof.

In this mixture/blend/composite, the lithium ion-conducting material is dispersed in the network of conducting polymer chains and is preferably selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4. In some embodiments, the lithium ion-conducting material is dispersed in the network of conducting polymer chains and is selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

In certain embodiments, in addition to the invented cathode-protecting layer, an anode-protecting layer may be implemented between the anode active layer and the porous separator or solid electrolyte. This anode-protecting layer preferably has a thickness from 10 nm to 500 μm and comprises an electrically and ionically conducting network of cross-linked polymer chains having a lithium ion conductivity preferably from 10⁻⁸ to 5×10⁻² S/cm and an electron conductivity from 10⁻⁸ to 10³ S/cm. This anode-protecting layer and the cathode-protecting layer in the same battery cell may have the same or different chemical compositions (e.g. both may be PANi-based network or one layer being PANi-based network and the other PPy network-based).

The anode-protecting layer implemented between the anode active layer and the porous separator or solid electrolyte is mainly for the purpose of reducing or eliminating the lithium metal dendrite by providing a more stable Li metal-electrolyte interface that is more conducive to uniform deposition of Li metal during battery charges. The anode-protecting layer also acts to block the penetration of any dendrite, if initiated, from reaching the cathode. The anode-protecting layer, comprising network of crosslinked polymer chains, also appear to be capable of shrinking or expanding conformably, responsive to the thickness increase or decrease of the anode active material layer. Other advantages will become more transparent later.

The lithium metal secondary battery may comprise a rechargeable lithium metal cell, a lithium-sulfur cell, a lithium-selenium cell, a lithium-sulfur/selenium cell, or lithium-air or lithium-oxygen cell.

In summary, the disclosure provides a method of manufacturing a lithium battery, the method comprising: (a) providing an anode comprising an anode active material layer or an anode active material layer supported by an anode current collector; (b) providing a cathode comprising a cathode active material layer and a cathode-protecting layer in physical or ionic contact with the cathode active material layer; (c) providing an electrolyte/separator assembly in ionic contact with the anode active material layer and the cathode active material layer; and (d) combining the anode, the cathode, and electrolyte to form the battery; wherein the cathode-protecting layer has a thickness from 1 nm to 100 μm and comprises an electrically and ionically conducting network of cross-linked polymer chains having a lithium ion conductivity from 10⁻⁸ to 5×10⁻² S/cm and an electron conductivity from 10⁻⁸ to 10³ S/cm and the cathode-protecting layer is disposed between the cathode active material layer and the electrolyte/separator assembly.

Also provided is a method of improving the cycle stability of a lithium battery comprising an anode active material layer or an anode current collector, an electrolyte/separator assembly, and a cathode active material layer, the method comprising implementing a cathode-protecting layer between the cathode active material layer and the electrolyte/separator assembly; wherein the cathode-protecting layer has a thickness from 1 nm to 100 μm and comprises an electrically and ionically conducting network of cross-linked polymer chains having a lithium ion conductivity from 10⁻⁸ to 5×10⁻² S/cm and an electron conductivity from 10⁻⁸ to 10³ S/cm.

The above method may further comprise a step of implementing an anode-protecting layer between the anode active material layer (or the anode current collector) and the electrolyte/separator assembly, wherein the anode-protecting layer has a thickness from 1 nm to 100 μm and comprises an electrically and ionically conducting network of cross-linked polymer chains having a lithium ion conductivity from 10⁻⁸ to 5×10⁻² S/cm and an electron conductivity from 10⁻⁸ to 10³ S/cm.

### BRIEF DESCRIPTION OF THE DRAWINGS

FIG. 1 Schematic of a prior art lithium metal battery cell, containing an anode layer (a thin Li foil or Li coating deposited on a surface of a current collector, Cu foil), a porous separator, and a cathode active material layer, which is composed of particles of a cathode active material, a conductive additive (not shown) and a resin binder (not shown). A cathode current collector supporting the cathode active layer is also shown.

FIG. 2 Schematic of a presently invented lithium metal battery cell containing an anode layer (a thin Li foil or Li coating deposited on a surface of a current collector, Cu foil), a porous separator/electrolyte layer (or a layer of solid-state electrolyte), a cathode-protecting layer, and a cathode active material layer, which is composed of particles of a cathode active material, a conductive additive (not shown) and a resin binder (not shown). A cathode current collector supporting the cathode active layer is also shown.

FIG. 3 The specific intercalation capacity curves of two lithium cells: one cell having a cathode containing V₂O₅ particles and a conductive polymer network-based cathode-protecting layer disposed between the cathode active material layer and the electrolyte/separator assembly and the other cell having a cathode containing graphene-embraced V₂O₅ particles, but having no cathode-protecting layer.

FIG. 4 The specific capacity values of two lithium-LiCoO₂ cells (initially the cell being lithium-free); one cell featuring a conductive polymer network layer at the cathode and the other cell containing no cathode-protecting layer.

FIG. 5 The discharge capacity curves of two coin cells having a FeF₃-based of cathode active materials: (1) one cell having a conductive polymer network-protected cathode; and (2) the other cell having no cathode-protecting layer.

FIG. 6 Specific capacities of three lithium-FePc (organic) cells, each containing a Li foil anode, and a cathode layer of FePc/RGO particles: one cell containing both an anode-protecting layer and a cathode-protecting layer, a second cell containing a cathode-protecting layer but no anode protection, and a third cell having no cathode-protecting layer and no anode-protecting layer.

FIG. 7 The cathode specific capacity values of two Li—S cells having sulfur-impregnated activated carbon fibers as the cathode active material; one cell featuring a PANi network-based cathode-protecting layer and the other cell does not have a cathode-protecting layer.

### DESCRIPTION OF THE PREFERRED EMBODIMENTS

This disclosure is directed at a lithium metal secondary battery, which is preferably based on an organic electrolyte, a polymer gel electrolyte, an ionic liquid electrolyte, a quasi-solid electrolyte, or a solid-state electrolyte. The shape of a lithium metal secondary battery can be cylindrical, square, button-like, etc. The present disclosure is not limited to any battery shape or configuration or any type of electrolyte. The invented lithium secondary battery may be selected from any battery that makes use of lithium metal as the primary anode active material, including the lithium-sulfur cell, lithium-selenium cell, lithium sulfur/selenium cell, lithium-air cell, and the lithium rechargeable batteries; e.g. those lithium-ion cells, but having lithium metal or high-capacity anode active material (e.g. lithiated or un-lithiated Li particles) to replace graphite as the main anode active material.

The disclosure provides a lithium metal secondary battery, comprising a cathode, an anode, a cathode-protecting layer disposed between the cathode and a porous separator (typically impregnated with a liquid or gel electrolyte) or a solid-state electrolyte (in lieu of a porous separator).

In certain embodiments, the anode comprises a layer of lithium or lithium alloy having greater than 70% by weight of lithium metal in the lithium alloy (in the form of a foil, coating, or multiple particles aggregated together) as an anode active material layer. The cathode contains a cathode active material layer and a cathode-protecting layer, in contact with the cathode active material layer, wherein the cathode-protecting layer has a thickness from 10 nm to 100 μm (preferably less than 10 μm) and comprising an electrically and ionically conducting network of cross-linked polymer chains having a lithium ion conductivity from 10⁻⁸ to 5×10⁻² S/cm and an electron conductivity from 10⁻⁸ to 10³ S/cm.

The foil or coating of lithium or lithium alloy, as the anode active material layer or electrode, may be supported by a current collector (e.g. a Cu foil, a Ni foam, a porous layer of nano-filaments, such as membrane, paper, or fabric of graphene sheets, carbon nanofibers, carbon nano-tubes, etc. forming a 3D interconnected network of electron-conducting pathways).

In certain embodiments, the disclosure provides a lithium metal secondary battery comprising a cathode, an anode, an electrolyte-separator assembly disposed between the cathode and the anode, wherein the anode comprises an anode current collector without any substantial amount of lithium supported thereon when the battery cell is made. Lithium comes during and after the first battery charge operation and all subsequent re-charge steps. The cathode-protecting layer, disposed between the cathode active material layer and the electrolyte-separator assembly, has a thickness from 10 nm to 100 μm and comprises an electrically and ionically conducting network of cross-linked polymer chains having a lithium ion conductivity from 10⁻⁸ to 5×10⁻² S/cm and an electron conductivity from 10⁻⁸ to 10³ S/cm. The lithium ion source may be implemented in the cathode active material (as in a typical lithium-ion battery) or in the anode side (e.g. as a lithium foil or lithium coating coated on the surface of a current collector).

Preferably, the conducting network of cross-linked polymer chains comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof. The conducting network of cross-linked polymer chains may be in a dried state or may be impregnated with a liquid (e.g. organic solvent, ionic solid, etc.) to form a gel state.

In some embodiments, the electrolyte-separator assembly comprises an electrolyte or a porous separator and an electrolyte in ionic contact with the anode and the cathode. When the electrolyte contains a solid state electrolyte, a porous separator or membrane may or may not be necessary. A porous separator is normally required if the electrolyte is a liquid or gel electrolyte.

Also herein provided is a method of improving the cycle-life of a lithium metal secondary battery, the method comprising a procedure of implementing a cathode-protecting layer between a cathode active material layer and a porous separator-electrolyte assembly, wherein the cathode-protecting layer is in a physical contact with the cathode active material layer, has a thickness from 10 nm to 100 μm, and comprises a conducting network of cross-linked polymer chains. The anode active material layer preferably contains a layer of lithium or lithium alloy, in a form of a foil, coating, or aggregate of multiple particles, as an anode active material. In certain embodiments, the lithium metal does not exist initially when the cell is made; the needed lithium can come from the cathode side and deposit on a surface of a current collector when the cell undergoes the first charge.

Preferably, the cathode-protecting layer is a discrete layer (not to be dissolved in the electrolyte) that is disposed between the cathode active material layer and the porous separator or solid state electrolyte. The cathode-protecting layer may contain a liquid electrolyte that permeates or impregnates into the conducting network of cross-linked polymer chains.

The presence of such a cathode-protecting layer appears to have significantly reduced or eliminated the shuttle effect commonly associated with the lithium-sulfur cell, lithium-selenium cell, and lithium-organic cathode cell.

The lithium battery may further comprise an anode-protecting layer disposed between the anode active material layer (or the anode current collector) and the electrolyte/separator assembly. We have discovered that the anode-protecting layer provides several unexpected benefits: (a) the formation of dendrite has been essentially eliminated; (b) uniform deposition of lithium back to the anode side is readily achieved; (c) the layer ensures smooth and uninterrupted transport of lithium ions from/to the lithium foil/coating layer (or the anode current collector layer) and through the interface between the lithium foil/coating and the protective layer with minimal interfacial resistance; (d) significant reduction in the amount of dead lithium particles near the Li foil; and (e) cycle stability can be significantly improved and cycle life increased.

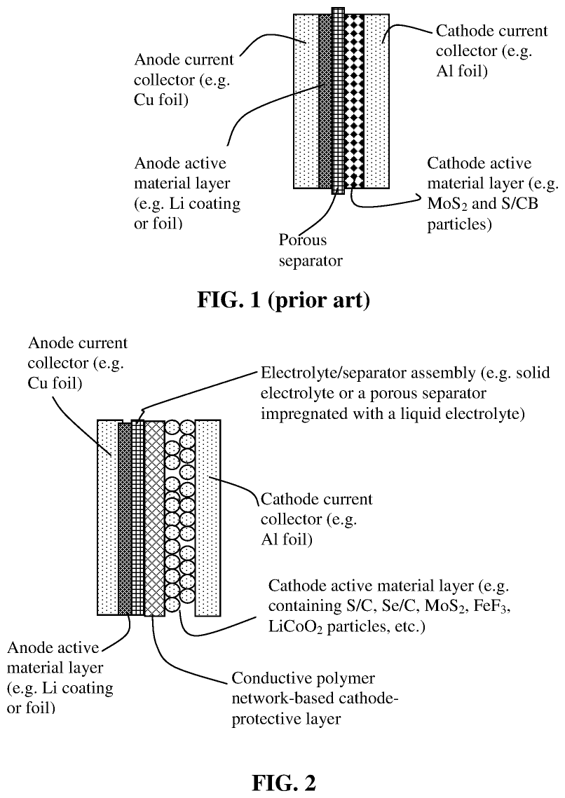

In a conventional lithium metal cell, as illustrated in FIG. 1, the anode active material (lithium) is deposited in a thin film form or a thin foil form directly onto an anode current collector (e.g. a Cu foil). The battery can be a lithium metal battery, lithium sulfur battery, lithium-air battery, lithium-selenium battery, etc. As previously discussed in the Background section, these lithium secondary batteries have the dendrite-induced internal shorting and “dead lithium” issues at the anode.

We have solved these challenging issues that have troubled battery designers and electrochemists alike for more than 30 years by developing and implementing an anode-protecting layer disposed between the lithium foil/coating and the separator/electrolyte layer. As schematically shown in FIG. 2, one embodiment of the present disclosure is a lithium metal battery cell containing an anode layer (e.g. a thin Li foil or Li coating deposited on a surface of a current collector, such as a layer of graphene foam or a sheet of Cu foil), a porous separator, a cathode-protecting layer, and a cathode active material layer, which is typically composed of particles of a cathode active material, a conductive additive (not shown) and a resin binder (not shown). A cathode current collector (e.g. Al foil) supporting the cathode active layer is also shown in FIG. 2. The lithium metal or alloy in the anode may be in a form of particles (e.g. surface-protected or surface-stabilized particles of Li or Li alloy).

A porous separator is shown in FIG. 2; an electrolyte (e.g. a liquid or gel polymer electrolyte) may impregnate into pores of the separator and ionically connect the anode with the cathode. If a solid state electrolyte is used, it may not be necessary to implement a porous separator membrane between the anode active layer and the cathode. Herein, the electrolyte/separator assembly typically refers to (1) a combination of an electrolyte (present in both the anode and the cathode sides) and a porous separator or membrane that electronically isolates the anode from the cathode, or (2) a solid-state electrolyte alone, which plays the dual roles of electronically isolating the anode from the cathode and ionically connects the anode with the cathode.

If the cathode side contains some lithium ion source (e.g. Li in LiCoO₂ or LiMn₂O₄, etc.), the anode side can have only a current collector layer (no Li foil or coating layer when the cell is made).

Again, it may be noted that although FIG. 2 shows a lithium coating pre-existing at the anode when the lithium battery is made, this is but one of several embodiments of the instant disclosure. An alternative embodiment is a lithium battery that does not contain a lithium foil or lithium coating at the anode (only an anode current collector, such as a Cu foil or a graphene/CNT mat) when the battery is made. The needed amount of lithium to be bounced back and forth between the anode and the cathode is initially stored in the cathode active material (e.g. lithium vanadium oxide LiₓV₂O₅, instead of vanadium oxide, V₂O₅; or lithium transition metal oxide or phosphate, instead of, say, MoS₂). During the first charging procedure of the lithium battery (e.g. as part of the electrochemical formation process), lithium comes out of the cathode active material, migrates to the anode side, and deposits on the anode current collector. The presence of the presently invented anode-protecting layer enables uniform deposition of lithium ions on the anode current collector surface. Such an alternative battery configuration avoids the need to have a layer of lithium foil or coating being present during battery fabrication. Bare lithium metal is highly sensitive to air moisture and oxygen and, thus, is more challenging to handle in a real battery manufacturing environment. This strategy of pre-storing lithium in the lithiated (lithium-containing) cathode active materials, such as LiₓV₂O₅ and Li₂Sₓ, makes all the materials safe to handle in a real manufacturing environment. Cathode active materials, such as LiₓV₂O₅ and Li₂Sₓ, are typically less air-sensitive.

The presently invented lithium secondary batteries can contain a wide variety of cathode active materials. The cathode active material layer may comprise a cathode active material selected from an inorganic material, an organic material, a polymeric material, or a combination thereof. The inorganic material may be selected from a metal oxide, metal phosphate, metal silicide, metal selenide, transition metal sulfide, or a combination thereof.

The inorganic cathode active material may be selected from a lithium cobalt oxide, lithium nickel oxide, lithium manganese oxide, lithium vanadium oxide, lithium-mixed metal oxide (e.g. the well-known lithium nickel cobalt aluminum oxide, NCA, and lithium nickel cobalt manganese oxide, NCM), lithium iron phosphate, lithium manganese phosphate, lithium vanadium phosphate, lithium mixed metal phosphate, lithium metal silicide, or a combination thereof.

In certain preferred embodiments, the inorganic material as a cathode active material for the lithium battery is selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In certain preferred embodiments, the inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

In certain preferred embodiments, the inorganic material as a cathode active material is selected from a transition metal dichalcogenide, a transition metal trichalcogenide, or a combination thereof. The inorganic material is selected from TiS₂, TaS₂, MoS₂, NbSe₃, MnO₂, CoO₂, an iron oxide, a vanadium oxide, or a combination thereof.

The cathode active material layer may contain a metal oxide containing vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, tavorite compound LiMPO₄F, borate compound LiMBO₃, or a combination thereof, wherein M is a transition metal or a mixture of multiple transition metals.

In some embodiments, the inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The cathode active material layer may contain an organic material or polymeric material selected from poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, hexaazatrinaphtylene (HATN), hexaazatriphenylene hexacarbonitrile (HAT(CN)₆), 5-benzylidene hydantoin, isatine lithium salt, pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAM), calixquinone, Li₄C₆O₆, Li₂C₆O₆, Li₆C₆O₆, or a combination thereof.

The thioether polymer is selected from poly[methanetetryl-tetra(thiomethylene)] (PMTTM), poly(2,4-dithiopentanylene) (PDTP), a polymer containing poly(ethene-1,1,2,2-tetrathiol) (PETT) as a main-chain thioether polymers, a side-chain thioether polymer having a main-chain consisting of conjugating aromatic moieties, and having a thioether side chain as a pendant, poly(2-phenyl-1,3-dithiolane) (PPDT), poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

In other embodiments, the cathode active material layer contains an organic material selected from a phthalocyanine compound, such as copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

In certain embodiments, the cathode active material comprises a sulfur-containing or selenium-containing material selected from a sulfur-carbon hybrid, sulfur-graphite hybrid, sulfur-graphene hybrid, conducting polymer-sulfur hybrid, metal sulfide, sulfur compound, selenium-carbon hybrid, selenium-graphite hybrid, selenium-graphene hybrid, conducting polymer-selenium hybrid, metal selenide, selenium compound, a S/Se alloy, a S/Se mixture, a Se/S compound, or a combination thereof.

The cathode-protecting layer may further contain a high-strength material dispersed therein to improve the structural integrity of the cathode-protecting layer. It is also advantageous to disperse a high-strength reinforcement material in the anode-protecting material to increase the strength and dendrite-penetrating resistance of the network of crosslinked polymer chains layer. Suitable reinforcement materials include glass fibers, ceramic fibers (e.g. silicon carbide fibers), polymer fibers (e.g. aromatic polyamide fibers such as Kevlar fibers, nylon fibers, ultrahigh molecular weight polyethylene or UHMW-PE fibers, etc.), and ceramic discs, etc.

Typically, a conjugated polymer is originally in a monomer or oligomer state that can be polymerized and cured to form a cross-linked polymer. Prior to curing, these polymers or oligomers may be soluble in an organic solvent to form a polymer solution. Thus, the preparation of the instant protecting layer may begin with an uncured conjugated polymer, reactive monomer, or growing oligomer in a liquid state (e.g. containing an oxidative initiator, a cross-linking agent, and a monomer in a liquid state) to form a reactive solution. An ion-conducting additive or a reinforcement material may be added to this solution to form a suspension. This solution or suspension can then be formed into a thin layer of polymer precursor on a surface of a cathode active layer. The polymer precursor (e.g. oligomer or monomer and initiator, along with a crosslinker and optional dopant) is then polymerized and cured to form a lightly cross-linked conductive polymer. This thin layer of conductive network polymer may be tentatively deposited on a solid substrate (e.g. surface of a polymer or glass), dried, and separated from the substrate to become a free-standing polymer layer. This free-standing layer is then laid on a cathode active material layer or implemented between the electrolyte/separator assembly and a cathode active layer. Polymer layer formation can be accomplished by using one of several procedures well-known in the art; e.g. spraying, spray-painting, printing, coating, extrusion-based film-forming, casting, etc.

One may dispense and deposit a layer of a conducting network polymer onto a primary surface of the cathode active material layer. Further alternatively, one may prepare a separate free-standing discrete layer of the conducting network polymer first. This conducting network polymer layer is then laminated between a cathode active material layer and a porous separator layer/electrolyte assembly, and combined with an anode to form a battery cell.

The disclosure also provides a method of manufacturing a lithium battery, the method comprising: (a) providing an anode comprising an anode active material layer or an anode active material layer supported by an anode current collector; (b) providing a cathode comprising a cathode active material layer and a cathode-protecting layer in physical or ionic contact with the cathode active material layer; (c) providing an electrolyte/separator assembly in ionic contact with the anode active material layer and the cathode active material layer; and (d) combining the anode, the cathode, and electrolyte to form the battery; wherein the cathode-protecting layer has a thickness from 1 nm to 100 μm and comprises an electrically and ionically conducting network of cross-linked polymer chains having a lithium ion conductivity from 10⁻⁸ to 5×10⁻² S/cm and an electron conductivity from 10⁻⁸ to 10³ S/cm and the cathode-protecting layer is disposed between the cathode active material layer and the electrolyte/separator assembly.

Also provided is a method of improving the cycle stability of a lithium battery comprising an anode active material layer or an anode current collector, an electrolyte/separator assembly, and a cathode active material layer, the method comprising implementing a cathode-protecting layer between the cathode active material layer and the electrolyte/separator assembly;

wherein the cathode-protecting layer has a thickness from 1 nm to 100 μm and comprises an electrically and ionically conducting network of cross-linked polymer chains having a lithium ion conductivity from 10⁻⁸ to 5×10⁻² S/cm and an electron conductivity from 10⁻⁸ to 10³ S/cm.

The above method may further comprise a step of implementing an anode-protecting layer between the anode active material layer (or the anode current collector) and the electrolyte/separator assembly, wherein the anode-protecting layer has a thickness from 1 nm to 100 μm and comprises an electrically and ionically conducting network of cross-linked polymer chains having a lithium ion conductivity from 10⁻⁸ to 5×10⁻² S/cm and an electron conductivity from 10⁻⁸ to 10³ S/cm.

In certain embodiments, the presently invented lithium secondary battery comprises at least the following layers: an anode current collector (e.g. a Cu foil or a graphene foam) or an anode active material layer (e.g. a discrete lithium foil, a lithium coating layer, or a layer of lithium particles) supported by an anode current collector, an electrolyte or combined porous separator/electrolyte, a cathode-protecting layer (network of crosslinked conductive polymer chains) substantially fully covering the cathode active material layer, a cathode active material layer supported on an optional cathode current collector (e.g. Al foil, graphene paper sheet, etc.).

There are many different sequences with which these individual layers may be produced and combined together to make a battery cell. For instance, one may produce all components in a free-standing film form and then combine them together. Alternatively, one may produce certain components in single free-standing films but other components in a 2-layer or 3-layer structure, followed by combining these components and structures together. For instance, one may spray, cast, or coat a layer of a desired conducting network polymer onto a primary surface of a cathode supported on an Al foil current collector to form a three-layer structure. This three-layer structure is then laminated with other components (e.g. a porous separator, an anode active layer, and electrolyte) to form a battery cell. The electrolyte may be added before or during the cell is made (if a solid or semi-solid electrolyte) or after the cell is made (if a liquid electrolyte).

Alternatively, the step of implementing a cathode-protecting layer may be conducted by depositing a layer of the desired conducting network polymer onto one primary surface of a cathode active material layer. This step includes optionally compressing the protected cathode to improve the contact between the cathode-protecting layer and the cathode active material layer, followed by combining the protected cathode, a separator, and an anode together to form a lithium metal secondary battery. A good contact between the cathode active material layer and the cathode-protecting layer is essential to reducing internal resistance.

In certain embodiments, the step of implementing a cathode-protecting layer is conducted by forming a protecting layer of conducting network polymer, followed by laminating the cathode active material layer, the conducting network polymer layer, a porous membrane, an anode layer, along with the electrolyte to form the lithium metal secondary battery, wherein an optional (but desirable) compressive stress is applied to improve the contact between the cathode-protecting layer and the cathode active material layer during or after this laminating step.

In some embodiments, the conducting network polymer can form a polymer matrix composite containing a lithium ion-conducting additive dispersed in the elastomer matrix material, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4. In some embodiments, the conducting network polymer can be mixed with a lithium ion-conducting additive, which contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

The electrolyte for a lithium secondary cell may be an organic electrolyte, ionic liquid electrolyte, gel polymer electrolyte, quasi-solid electrolyte (e.g. containing 2M-14 M of a lithium salt in a solvent) or a combination thereof. The electrolyte typically contains an alkali metal salt (lithium salt, sodium salt, and/or potassium salt) dissolved in a solvent.

The solvent may be selected from 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, a room temperature ionic liquid solvent, or a combination thereof.

The electrolytic salts to be incorporated into a non-aqueous electrolyte may be selected from a lithium salt such as lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), an ionic liquid salt, sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-methanesulfonate (NaCF₃SO₃), potassium trifluoro-methanesulfonate (KCF₃SO₃), bis-trifluoromethyl sulfonylimide sodium (NaN(CF₃SO₂)₂), sodium trifluoromethanesulfonimide (NaTFSI), and bis-trifluoromethyl sulfonylimide potassium (KN(CF₃SO₂)₂). Among them, LiPF₆, LiBF₄ and LiN(CF₃SO₂)₂ are preferred for Li—S cells, NaPF₆ and LiBF₄ for Na—S cells, and KBF₄ for K—S cells. The content of aforementioned electrolytic salts in the non-aqueous solvent is preferably 0.5 to 3.0 M (mol/L) at the cathode side and 3.0 to >10 M at the anode side.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N,N-bis(trifluoromethane)sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a lithium metal cell.

### Example 1: Production of PEDOT:PSS Network-Based Cathode-Protecting Layers

Poly(3,4-ethylenedioxythiophene):polystyrene sulfonate (PEDOT:PSS) is a polymer mixture of two ionomers. One component is made up of sodium polystyrene sulfonate (PSS), which is a sulfonated polystyrene. Part of the sulfonyl groups are deprotonated and carry a negative charge. The other component poly(3,4-ethylenedioxythiophene) or PEDOT is a conjugated polymer, polythiophene, which carries positive charges. Together the two charged polymers form a macromolecular salt. The PEDOT/PSS, with a curing agent, was dissolved in water and the solution was cast on a glass surface and dried to form a film. In one example, a 5% by weight of graphene sheets was dispersed in the solution to make a graphene-reinforced conducting polymer network composite film. These films were each laminated between a cathode active material layer and a porous membrane or solid electrolyte, along with an anode and other components to make a lithium metal cell.

### Example 2: Cathode-Protecting Layers Comprising a Conductive Network of Crosslinked Polypyrrole (PPy) Chains

The process of example 1 was replicated with PEDOT/PSS being replaced by polypyrrole (PPy) network. The polypyrrole hydrogel was prepared by following the following procedure: Solution A was prepared by mixing 1 mL H₂O and 0.5 mL phytic acid together and then injecting 142 μL pyrrole into the solution, which was sonicated for 1 min. Solution B was prepared by dissolving 0.114 g ammonium persulfate in 0.5 mL H₂O. The solution A and B were separately cooled to 4° C. and then solution B was added into solution A quickly to form a reacting precursor solution.

The precursor solution was rapidly coated on a glass surface and reacted to produce a layer of polypyrrole hydrogel. The polypyrrole hydrogel layer was totally dried by removing all of the water content from the gel under vacuum at 60° C. for 24 hours to form a polypyrrole network film.

### Example 3: Production of Networks of Crosslinked Polyaniline Chain-Based Cathode-Protecting Layers

In some embodiments, the precursor may contain a monomer, an initiator, oxidizer or catalyst, a crosslinking agent, and an optional dopant. As an example, 3.6 ml solution A was prepared, which contained 400 mM aniline monomer and 120 mM phytic acid (as a crosslinking agent and a dopant) in water. Subsequently, 1.2 ml solution B, containing 500 mM ammonium persulfate (oxidative initiator), was added into the above solution A and subjected to bath sonication for 1 min. The mixed solution was sprayed to deposit a reacting mass onto a glass surface. In about 3-10 min, the solution changed color from brown to dark green and became viscous and gel-like, indicating in-situ polymerization of aniline monomer to form the PANi hydrogel. The PANi hydrogel layer was totally dried by removing all of the water content from the gel under vacuum at 60° C. for 24 hours to form a PANi network film (as a cathode-protecting layer). On a separate basis, 3% by weight of CNTs was added into the reacting mass during bath sonication for the formation of a separate layer of CNT-reinforced PANi network.

### Examples 4: Heparin-Based Material as a Curing Agent for the Preparation of a Conducting Network of Polyaniline Chains

The conducting networks of crosslinked PANi may be produced from a monomer using heparin-based crosslinking agent (e.g. instead of or in addition to phytic acid). Aqueous solutions of heparin (0.21% w/w) were prepared using 5M NaOH. Photo-crosslinkable heparin methacrylate (Hep-MA) precursors were prepared by combining heparin (porcine source, Mw˜1719 kDa) incubated with methacrylic anhydride (MA) and adjusted to pH=8. The degree of substitution (DS) of methacrylate groups covalently linked to heparin precursors was measured by 1H nuclear magnetic resonance. The DS was determined from integral ratios of peaks of the methacrylate groups at 6.2 ppm relative to the peak corresponding to methyl groups in heparin at 2.05 ppm.

Solutions used for photo-polymerization were incubated with 2-methyl-1-[4-(hydeoxyethoxy)phenyl]-2-methyl-1-propanone (Irgacure 2959) to create final concentrations of 0.5% (w/w) of photoinitiator. The solution was then cast onto a glass surface. Gels were photo-crosslinked using UV illumination for 30-60 min (λmax=365 nm, 10 mW/cm²). Hep-MA/PANI dual-networks were formed by sequentially incubating cross-linked Hep-MA hydrogels in aqueous solutions of ANI ([ANI]₀, between 0.1 and 2 M, 10 min) and acidic solutions of APS ([APS]₀, between 12.5 mM and 2 M, 20120 min). The gel fraction of Hep-MA/PANI dual networks was recovered by washing in di H₂O after oxidative polymerization. The films were then vacuum-dried at 50° C. for 24 hours to obtain a layer of network of crosslinked PANi chains coated on graphene foam.

### Example 5: Lithium Battery Containing a Conductive Network Polymer-Protected Cathode Layer Containing V₂O₅ Particles as a Cathode Active Material

Cathode active material layers were prepared from V₂O₅ particles and graphene-embraced V₂O₅ particles, respectively. The V₂O₅ particles were commercially available. Graphene-embraced V₂O₅ particles were prepared in-house. In a typical experiment, vanadium pentoxide gels were obtained by mixing V₂O₅ in a LiCl aqueous solution. The Li⁺-exchanged gels obtained by interaction with LiCl solution (the Li:V molar ratio was kept as 1:1) was mixed with a GO suspension and then placed in a Teflon-lined stainless steel 35 ml autoclave, sealed, and heated up to 180° C. for 12 h. After such a hydrothermal treatment, the green solids were collected, thoroughly washed, ultrasonicated for 2 minutes, and dried at 70° C. for 12 h followed by mixing with another 0.1% GO in water, ultrasonicating to break down nano-belt sizes, and then spray-drying at 200° C. to obtain graphene-embraced V₂O₅ composite particulates. Selected amounts of V₂O₅ particles and graphene-embraced V₂O₅ particles, respectively, were then each made into a cathode layer following a well-known slurry coating process.

The conductive network polymer layers for use a cathode-protecting layer were those prepared in Example 1. A Cu foil was used to support a Li foil as the anode active material layer.

For electrochemical testing, the working electrodes (cathode layers) were prepared by mixing 85 wt. % V₂O₅ or 88% of graphene-embraced V₂O₅ particles, 5-8 wt. % CNTs, and 7 wt. % polyvinylidene fluoride (PVDF) binder dissolved in N-methyl-2-pyrrolidinoe (NMP) to form a slurry of 5 wt. % total solid content. After coating the slurries on Al foil, the electrodes were dried at 120° C. in vacuum for 2 h to remove the solvent before pressing. Then, the electrodes were cut into a disk (ϕ=12 mm) and dried at 100° C. for 24 h in vacuum.

Electrochemical measurements were carried out using CR2032 (3V) coin-type cells with lithium metal as the counter electrode (actually an anode of a Li-transition metal oxide cell), Celgard 2400 membrane as separator (for the cell containing no anode-protecting elastomer layer), and 1 M LiPF₆ electrolyte solution dissolved in a mixture of ethylene carbonate (EC) and diethyl carbonate (DEC) (EC-DEC, 1:1 v/v). The cell assembly was performed in an argon-filled glove-box. The CV measurements were carried out using a CH-6 electrochemical workstation at a scanning rate of 1 mV/s. The electrochemical performance of the cells was evaluated by galvanostatic charge/discharge cycling at a current density of 50 mA/g using an Arbin Electrochemical Testing Station.

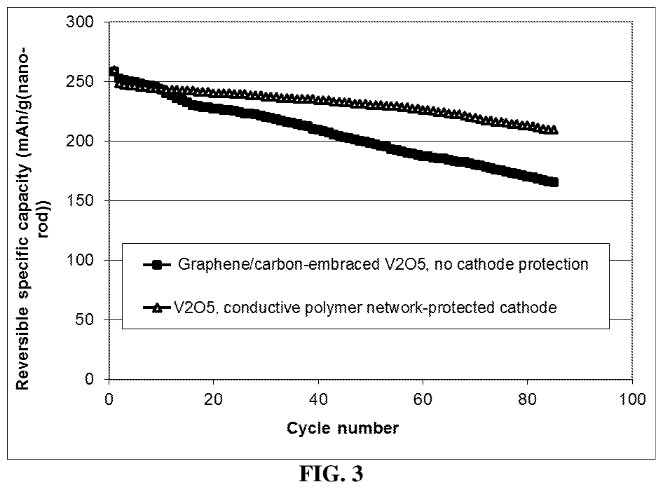

Summarized in FIG. 3 are the specific intercalation capacity curves of two lithium cells: one cell having a cathode containing V₂O₅ particles and a PEDOT:PSS network-based cathode-protecting layer disposed between the cathode active material layer and the separator layer and the other cell having a cathode containing graphene-embraced V₂O₅ particles, but having no cathode-protecting layer. As the number of cycles increases, the specific capacity of the un-protected cells drops at a much faster rate. In contrast, the presently invented approach of a conductive polymer network-based cathode-protecting layer provides the battery cell with a stable cycling behavior. These data have clearly demonstrated the surprising and superior performance of the presently invented cathode protection approach for the lithium metal layer.

### Example 6: Conductive Network of Crosslinked Polypyrrole (PPy) Chains Implemented in the Cathode of a Lithium-LiCoO₂ Cell

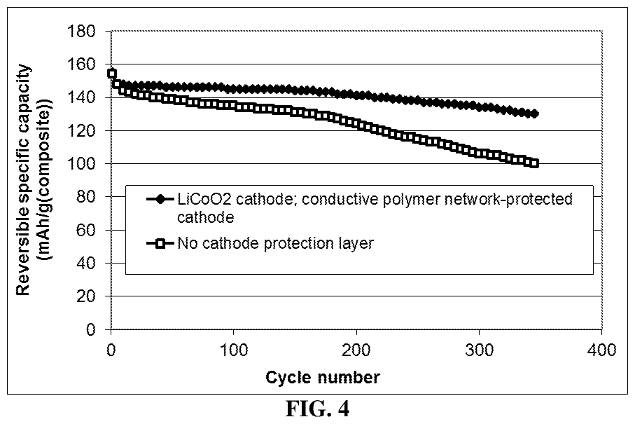

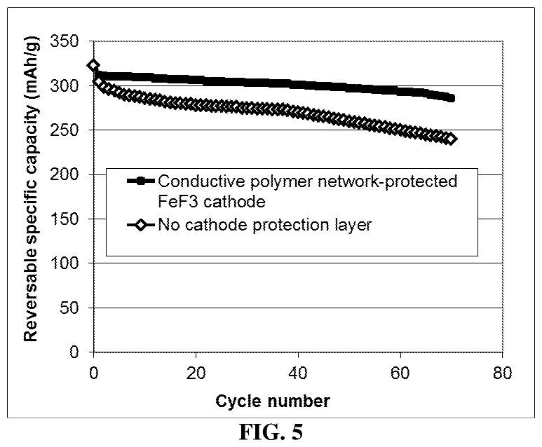

The conducting polymer network-based cathode-protecting layer was based on the conductive network of crosslinked polypyrrole (PPy) chains prepared according to a procedure used in Example 2. FIG. 4 shows the specific lithium intercalation capacity of two lithium-LiCoO₂ cells (initially the cell being substantially lithium-free); one cell featuring a layer of conductive network of crosslinked polypyrrole (PPy) chains at the cathode and the other cell containing no cathode protection layer. These data indicate that the cell having a conductive network of crosslinked polypyrrole (PPy) chains-based cathode-protecting layer offers significantly more stable cycling behavior.

### Example 7: Li Metal Cells Containing Transition Metal Fluoride Nanoparticle-Based Cathode and a PANi Network-Based Cathode-Protecting Layer

Commercially available powders of CoF₃, MnF₃, FeF₃, VF₃, VOF₃, TiF₃, and BiF₃ were subjected to high-intensity ball-milling to reduce the particle size down to approximately 0.5-2.3 μm. Each type of these metal fluoride particles, along with graphene sheets (as a conductive additive), was then added into an NMP and PVDF binder suspension to form a multiple-component slurry. The slurry was then slurry-coated on Al foil to form cathode layers.

Shown in FIG. 5 are the discharge capacity curves of two coin cells having the same cathode active material (FeF₃), but one cell having a PANi network-based cathode-protecting layer (prepared in Example 3) and the other cell having no protective layer. These results have clearly demonstrated that the conductive network polymer layer protection strategy provides the best protection against capacity decay of a lithium metal battery. The conductive network polymer layer appears to be capable of reversibly deforming without breakage when the anode layer expands and shrinks during discharge and charge.

### Example 8: Li-Organic Cell Containing a Naphthalocyanine/Reduced Graphene Oxide (FePc/RGO) Particulate Cathode and a Cathode-Protecting Layer

Particles of combined FePc/graphene sheets were obtained by ball-milling a mixture of FePc and RGO in a milling chamber for 30 minutes. The resulting FePc/RGO mixture particles were potato-like in shape. Three lithium cells were prepared, each containing a Li foil anode, and a cathode layer of FePc/RGO particles; one cell containing both an anode-protecting layer and a cathode-protecting layer (prepared in Example 4), a second cell containing a cathode-protecting layer (prepared in Example 4) but no anode protection, and a third cell having no cathode-protecting layer and no anode-protecting layer.

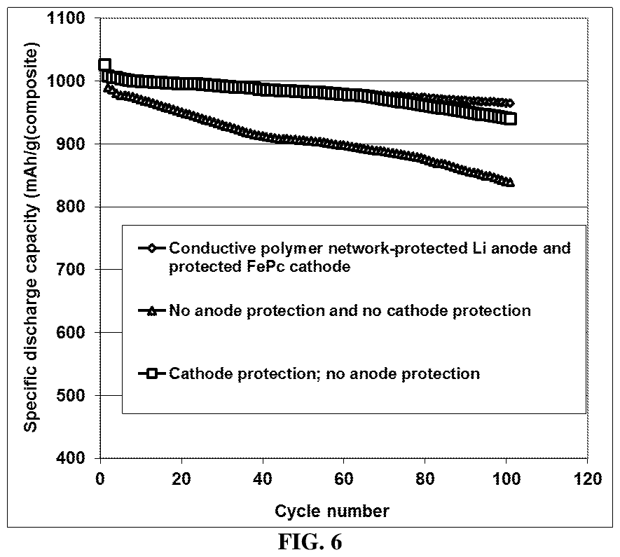

The cycling behaviors of these 3 lithium-organic cells are shown in FIG. 6, which indicates that the lithium-organic cell having a conductive network polymer-based anode-protection layer and cathode protection layer (prepared in Example 4) exhibits the most stable cycling response. The anode protection layer eliminates the lithium dendrite issue and reduces the formation of dead lithium particles at the anode. The cathode-protecting layer reduces or eliminates the migration of the organic species from the cathode to the anode side. By eliminating the shuttle effect, the cathode protection approach can significantly increase the cycle life of all lithium-organic batteries. When both the anode-protecting layer and cathode-protecting layer are included in the same lithium battery, the most stable cycle performance can be achieved.

### Example 9: Lithium-Sulfur Cell Having Sulfur-Impregnated Activated Carbon Fibers as the Cathode Active Material

A chemical impregnation method was herein utilized to prepare S-impregnated carbon fibers that had been chemically activated. The procedure began with adding 0.58 g Na₂S into a flask that had been filled with 25 ml distilled water to form a Na₂S solution. Then, 0.72 g elemental S was suspended in the Na₂S solution and stirred with a magnetic stirrer for about 2 hours at room temperature. The color of the solution changed slowly to orange-yellow as the sulfur dissolved. After dissolution of the sulfur, a sodium polysulfide (Na₂Sₓ) solution was obtained (x=4-10).

Subsequently, a sulfur-impregnated carbon fiber sample was prepared by a chemical impregnation method in an aqueous solution. First, 180 mg of expansion-treated carbon fibers was suspended in 180 ml ultrapure water with a surfactant and then sonicated at 50° C. for 5 hours to form a stable carbon fiber dispersion. Subsequently, the Na₂Sₓ solution was added to the above-prepared dispersions in the presence of 5 wt % surfactant cetyl trimethyl-ammonium bromide (CTAB), the as-prepared carbon fiber/Na₂Sₓ blended solution was sonicated for another 2 hours and then titrated into 100 ml of 2 mol/L HCOOH solution at a rate of 30-40 drops/min and stirred for 2 hours. Finally, the precipitate was filtered and washed with acetone and distilled water several times to eliminate salts and impurities. After filtration, the precipitate was dried at 50° C. in a drying oven for 48 hours. The reaction may be represented by the following reaction: Sₓ²⁻+2H⁺→(x−1)S+H₂S. The resulting sulfur-impregnated carbon fibers were used as a cathode active material for a lithium-sulfur cell, wherein the anode is a thin lithium metal coated on a graphene-based current collector.

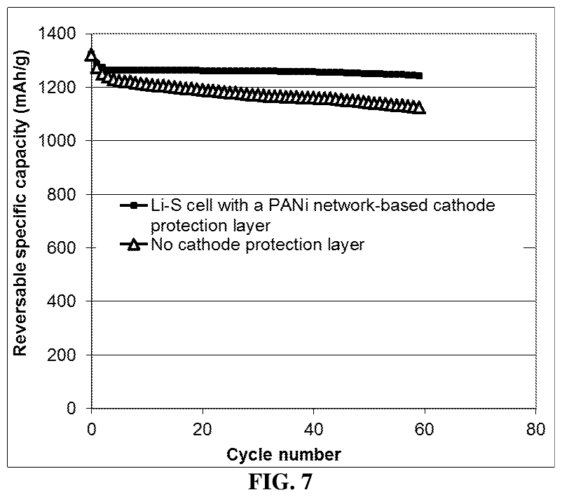

The cycling behaviors of these 2 lithium cells are shown in FIG. 7, which indicates that the lithium-sulfur cell having a conductive network polymer-based cathode protection layer (prepared in Example 3) exhibits a significantly more stable cycling response. The cathode protection layer appears to be effective in eliminating the shuttle effect.

### Example 10: Cycle Stability of Various Rechargeable Lithium Battery Cells

In lithium-ion battery industry, it is a common practice to define the cycle life of a battery as the number of charge-discharge cycles that the battery suffers a 20% decay in capacity based on the initial capacity measured after the required electrochemical formation. Summarized in Table 1 below are the cycle life data of a broad array of batteries featuring an anode with or without an anode-protecting layer of a conductive network polymer.

TABLE 1
Cycle life data of various lithium secondary (rechargeable) batteries.

| | Cathode-protecting | | Initial | Cycle life |
|---|---|---|---|---|
| | conductive polymer | Type & % of cathode active | capacity | (No. of |
| Sample ID | network | material | (mAh/g) | cycles) |
| CuCl₂-1e | PPy network | 85% by wt. CuCl₂ particles (80 | 540 | 1044 |
| | | nm) + 7% graphite + 8% binder | | |
| CuCl₂-2e | none | 85% by wt. CuCl₂ particles (80 | 536 | 112 |
| | | nm) + 7% graphite + 8% binder | | |
| BiF₃-1e | none | 85% by wt. BiFe₃ particles + 7% | 275 | 115 |
| | | graphene + 8% binder | | |
| BiF₃-2e | PPy network + 20% | 85% by wt. BiFe₃ particles + 7% | 276 | 868 |
| | LiNO₃ | graphene + 8% binder | | |
| Li₂MnSiO₄- | PANi network | 85% C-coated Li₂MnSiO₄ + 7% | 254 | 1,338 |
| 1e | | CNT + 8% binder | | |
| Li₂MnSiO₄- | none | 85% C-coated Li₂MnSiO₄ + 7% | 252 | 543 |
| 2e | | CNT + 8% binder | | |
| Li₆C₆O₆-1e | PANi network + 5% | Li₆C₆O₆-graphene ball-milled | 439 | 1,266 |
| | Kevlar fibers | | | |
| Li₆C₆O₆-2e | none | Li₆C₆O₆-graphene ball-milled | 438 | 116 |
| MoS₂-1e | Glass fiber reinforced | 85% MoS₂ + 8% graphite + | 224 | 1,012 |
| | PANi network | binder | | |
| MoS₂-2e | none | 85% MoS₂ + 8% graphite + | 225 | 156 |
| | | binder | | |

We have further observed that by adding conductive polymer network-based anode-protecting layer, along with a cathode-protecting layer, we have not only eliminated/reduced the shuttling effect, but also alleviated the problems of lithium metal dendrite formation and lithium metal-electrolyte reactions that otherwise lead to rapid capacity decay and potentially internal shorting and explosion of the lithium secondary batteries. The conductive polymer network layer appears to be capable of expanding or shrinking congruently or conformably with the anode active material layer. This capability helps to maintain a good contact between the current collector (or the lithium film itself) and the protective layer, enabling uniform re-deposition of lithium ions without interruption. The best cycle performance is achieved with a lithium battery when both an anode-protecting layer and a cathode-protecting layer are implemented.

We claim:

1. A lithium metal secondary battery comprising a cathode, an anode, and an electrolyte-separator assembly disposed between said cathode and said anode, wherein said anode comprises an anode current collector or an anode active material layer supported by an anode current collector and said cathode comprises:
a) A cathode active material layer; and
b) A cathode-protecting layer in physical contact with said cathode active material layer and in ionic contact with said electrolyte-separator assembly, wherein said cathode-protecting layer has a thickness from 10 nm to 500 μm and comprising an electrically and ionically conducting network of cross-linked polymer chains having a lithium ion conductivity from 10⁻⁸ to 5×10⁻² S/cm and an electron conductivity from 10⁻⁸ to 10³ S/cm.

2. The lithium metal secondary battery of claim 1, wherein said electrolyte is selected from organic liquid electrolyte, ionic liquid electrolyte, polymer gel electrolyte, solid-state electrolyte, quasi-solid electrolyte having a lithium salt dissolved in an organic or ionic liquid with a lithium salt concentration higher than 2.0 M, or a combination thereof.

3. The lithium metal secondary battery of claim 1, wherein said conducting network of cross-linked polymer chains comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

4. The lithium metal secondary battery of claim 1, wherein said anode comprises an anode current collector but no anode active material when said battery is made.

5. The lithium metal secondary battery of claim 1, wherein said cathode-protecting layer further comprises a liquid solvent that permeates into said conducting network of cross-linked polymer chains to form a conductive polymer gel.

6. The lithium metal secondary battery of claim 2, wherein said cathode-protecting layer further comprises a liquid solvent that permeates into said conducting network of cross-linked polymer chains to form a conductive polymer gel.

7. The lithium metal secondary battery of claim 1, wherein said conducting network of cross-linked polymer chains further comprises from 0.01% to 50% of an electrically non-conducting reinforcement material dispersed in said conducting network of cross-linked polymer chains to form a conducting network polymer composite, wherein said reinforcement material is selected from a glass fiber, ceramic fiber, polymer fiber, glass particle, ceramic particle, polymer particle, or a combination thereof.

8. The lithium metal secondary battery of claim 1, wherein said conducting network of cross-linked polymer chains further contains from 0.1% to 40% by weight of a lithium ion-conducting additive dispersed therein.

9. The lithium metal secondary battery of claim 8, wherein said lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4.

10. The lithium metal secondary battery of claim 8, wherein said lithium ion-conducting additive contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

11. The lithium metal secondary battery of claim 1, wherein said cathode active material layer comprises a cathode active material selected from an inorganic material, an organic material, a polymeric material, sulfur, an alkali metal polysulfide, selenium, an alkali metal polyselenide, a Se/S alloy or mixture, or a combination thereof.

12. The lithium metal secondary battery of claim 11, wherein said inorganic material is selected from a metal oxide, metal phosphate, metal silicide, metal selenide, transition metal sulfide, or a combination thereof.

13. The lithium metal secondary battery of claim 11, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

14. The lithium metal secondary battery of claim 11, wherein said inorganic material is selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof.

15. The lithium metal secondary battery of claim 11, wherein said inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

16. The lithium metal secondary battery of claim 11, wherein said inorganic material is selected from a transition metal dichalcogenide, a transition metal trichalcogenide, or a combination thereof.

17. The lithium metal secondary battery of claim 11, wherein said inorganic material is selected from TiS₂, TaS₂, MoS₂, NbSe₃, MnO₂, CoO₂, an iron oxide, a vanadium oxide, or a combination thereof.

18. The lithium metal secondary battery of claim 12, wherein said metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

19. The lithium metal secondary battery of claim 12, wherein said metal oxide or metal phosphate is selected from a layered compound LiMO₂, spinel compound LiM₂O₄, olivine compound LiMPO₄, silicate compound Li₂MSiO₄, tavorite compound LiMPO₄F, borate compound LiMBO₃, or a combination thereof, wherein M is a transition metal or a mixture of multiple transition metals.

20. The lithium metal secondary battery of claim 11, wherein said inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

21. The lithium metal secondary battery of claim 11, wherein said organic material or polymeric material is selected from poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, quino(triazene), redox-active organic material, tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, hexaazatrinaphtylene (HATN), hexaazatriphenylene hexacarbonitrile (HAT(CN)₆), 5-benzylidene hydantoin, isatine lithium salt, pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

22. The lithium metal secondary battery of claim 21, wherein said thioether polymer is selected from poly[methanetetryl-tetra(thiomethylene)] (PMTTM), poly(2,4-dithiopentanylene) (PDTP), a polymer containing poly(ethene-1,1,2,2-tetrathiol) (PETT) as a main-chain thioether polymers, a side-chain thioether polymer having a main-chain consisting of conjugating aromatic moieties, and having a thioether side chain as a pendant, poly(2-phenyl-1,3-dithiolane) (PPDT), poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

23. The lithium metal secondary battery of claim 11, wherein said organic material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

24. The lithium metal secondary battery of claim 1, wherein said cathode active material comprises a sulfur- or selenium-containing material selected from a sulfur-carbon hybrid, sulfur-graphite hybrid, sulfur-graphene hybrid, conducting polymer-sulfur hybrid, metal sulfide, sulfur compound, selenium-carbon hybrid, selenium-graphite hybrid, selenium-graphene hybrid, conducting polymer-selenium hybrid, metal selenide, selenium compound, or a combination thereof.

25. The lithium metal secondary battery of claim 24, wherein said metal sulfide contains MₓS_{y} or said metal selenide contains MₓSe_{y}, wherein x is an integer from 1 to 3 and y is an integer from 1 to 10, and M is a metal element selected from an alkali metal, an alkaline metal selected from Mg or Ca, a transition metal, a metal from groups 13 to 17 of the periodic table, or a combination thereof.

26. The lithium metal secondary battery of claim 25, wherein said metal element M is selected from Li, Na, K, Mg, Zn, Cu, Ti, Ni, Co, Fe, or Al.

27. The lithium metal secondary battery of claim 24, wherein said metal sulfide contains Li₂S₁, Li₂S₂, Li₂S₃, Li₂S₄, Li₂S₅, Li₂S₆, Li₂S₇, Li₂S₈, Li₂S₉, Li₂S₁₀, and a combination thereof.

28. The lithium metal secondary battery of claim 1, wherein said anode further comprises an anode-protecting layer implemented between said anode active layer or current collector and said electrolyte-separator assembly, wherein said anode-protecting layer has a thickness from 10 nm to 500 μm and comprises an electrically and ionically conducting network of cross-linked polymer chains having a lithium ion conductivity preferably from 10⁻⁸ to 5×10⁻² S/cm and an electron conductivity from 10⁻⁸ to 10³ S/cm.

29. The lithium metal secondary battery of claim 1, wherein said lithium metal secondary battery comprises a rechargeable lithium metal cell, a lithium-sulfur cell, a lithium-selenium cell, a lithium-sulfur/selenium cell, or lithium-air or lithium-oxygen cell.

30. A method of manufacturing the lithium battery of claim 1, the method comprising: (a) providing an anode comprising an anode active material layer or an anode active material layer supported by an anode current collector; (b) providing a cathode comprising a cathode active material layer and a cathode-protecting layer in physical or ionic contact with said cathode active material layer; (c) providing an electrolyte/separator assembly in ionic contact with the anode active material layer and the cathode active material layer; and (d) combining said anode, cathode, and electrolyte to form said battery; wherein said cathode-protecting layer has a thickness from 1 nm to 100 μm and comprises an electrically and ionically conducting network of cross-linked polymer chains having a lithium ion conductivity from 10⁻⁸ to 5×10⁻² S/cm and an electron conductivity from 10⁻⁸ to 10³ S/cm and said cathode-protecting layer is disposed between the cathode active material layer and the electrolyte/separator assembly.

31. A method of improving cycle stability of a lithium battery comprising an anode active material layer or an anode current collector, an electrolyte/separator assembly, and a cathode active material layer, said method comprising implementing a cathode-protecting layer between said cathode active material layer and said electrolyte/separator assembly; wherein said cathode-protecting layer has a thickness from 1 nm to 100 μm and comprises an electrically and ionically conducting network of cross-linked polymer chains having a lithium ion conductivity from 10⁻⁸ to 5×10⁻² S/cm and an electron conductivity from 10⁻⁸ to 10³ S/cm.

32. The method of claim 31, further comprising a step of implementing an anode-protecting layer between said anode active material layer, or said anode current collector, and said electrolyte/separator assembly, wherein said anode-protecting layer has a thickness from 1 nm to 100 μm and comprises an electrically and ionically conducting network of cross-linked polymer chains having a lithium ion conductivity from 10⁻⁸ to 5×10⁻² S/cm and an electron conductivity from 10⁻⁸ to 10³ S/cm.

33. The method of claim 30, wherein said conducting network of cross-linked polymer chains comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

34. The method of claim 31, wherein said conducting network of cross-linked polymer chains comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

35. The method of claim 30, wherein said cathode active material layer comprises a cathode active material selected from an inorganic material, an organic material, a polymeric material, sulfur, an alkali metal polysulfide, selenium, an alkali metal polyselenide, a Se/S alloy or mixture, or a combination thereof.

36. The method of claim 31, wherein said cathode active material layer comprises a cathode active material selected from an inorganic material, an organic material, a polymeric material, sulfur, an alkali metal polysulfide, selenium, an alkali metal polyselenide, a Se/S alloy or mixture, or a combination thereof.
